(19) United States
(12) Patent Application Publication
(10) Pub. No.: US 2013/0141911 A1
(43) Pub. Date: Jun. 6, 2013

(54) LIGHT EMITTING DIODES CHANDERLIER

(71) Applicant: CHIN-YI CHEN, Taichung City (TW)

(72) Inventor: CHIN-YI CHEN, Taichung City (TW)

(21) Appl. No.: 13/311,559

(22) Filed: Dec. 6, 2011

(51) Int. Cl. F21V 29/00

(52) U.S. Cl. 362/249.02

(57) ABSTRACT

A Light Emitting Diodes chandelier includes a base board, a ventilation unit, a case and a cover. Multiple Light Emitting Diodes (LEDs) are located beneath the base board and the ventilation unit is located above the base board. The case is mounted to the base board and the cover is a transparent cover and located beneath the LEDs. The ventilation unit has multiple plates which contact the top of the ventilation unit. The plates and the case are made by heat-conductive material. The case has two openings defined in two ends thereof so as to provide better convection and brings heat away.

### BACKGROUND OF THE INVENTION

1. Field of the Invention

The present invention relates to a Light Emitting Diodes light unit, and more particularly, to a Light Emitting Diodes light unit with improved ventilation feature.

2. Description of the Prior Art

The use of Light Emitting Diodes (LEDs) is a trend in the lighting industry and the Light Emitting Diodes are compact in size, save energy, and have long term of use. However, for the mediate or low watts of LEDs, the ventilation is not a major problem, but the ventilation will be one of main concerns if the LEDs lighting unit uses multiple chips packed as one lighting unit or multiple LEDs. Although the multiple LEDs generate concentrated light beam, they generate significant heat during use so that ventilation has to be improved.

Some manufacturers increase the ventilation area to quickly bring the heat away, however, there may not have sufficient space for the increase of the ventilation area. Some manufacturers install a fan at the inlet of the ventilation unit and the fan creases and regulates air flows to bring more heat away so as to cool the ventilation unit quickly. Nevertheless, the fan needs electric power to activate it and which requires more space and cost.

The present invention intends to provide a ventilation unit for improving the shortcomings of the conventional ventilation units of the LEDs chandeliers.

### SUMMARY OF THE INVENTION

The present invention relates to a Light Emitting Diodes chandelier and comprises a base board, a ventilation unit, a case and a cover. Multiple Light Emitting Diodes (LEDs) are located beneath the base board and the ventilation unit is located above the base board. The case is mounted to the base board and the cover is a transparent cover and located beneath the LEDs. The ventilation unit has multiple plates which contact the top of the ventilation unit. The plates and the case are made by heat-conductive material. The case has two openings defined in two ends thereof so as to provide better convection and brings heat away.

The primary object of the present invention is to provide a ventilation unit for a Light Emitting Diodes chandelier and the case of the ventilation unit has two openings in two ends thereof so as to provide convection to bring heat away.

Another object of the present invention is to provide a ventilation unit wherein the case is made by heat-conductive material and directly contacts air to increase the convection of the cool and heat air.

The present invention will become more obvious from the following description when taken in connection with the accompanying drawings which show, for purposes of illustration only, a preferred embodiment in accordance with the present invention.

### BRIEF DESCRIPTION OF THE DRAWINGS

FIG. 1 is a perspective view to show the LEDs chandelier of the present invention;

FIG. 2 is a cross sectional view of the LEDs chandelier of the present invention;

FIG. 3 is another cross sectional view of the LEDs chandelier of the present invention;

FIG. 4 is a perspective view to show another embodiment of the LEDs chandelier of the present invention, and

FIG. 5 is a cross sectional view of the LEDs chandelier of the embodiment in FIG. 4 of the present invention.

### DETAILED DESCRIPTION OF THE PREFERRED EMBODIMENT

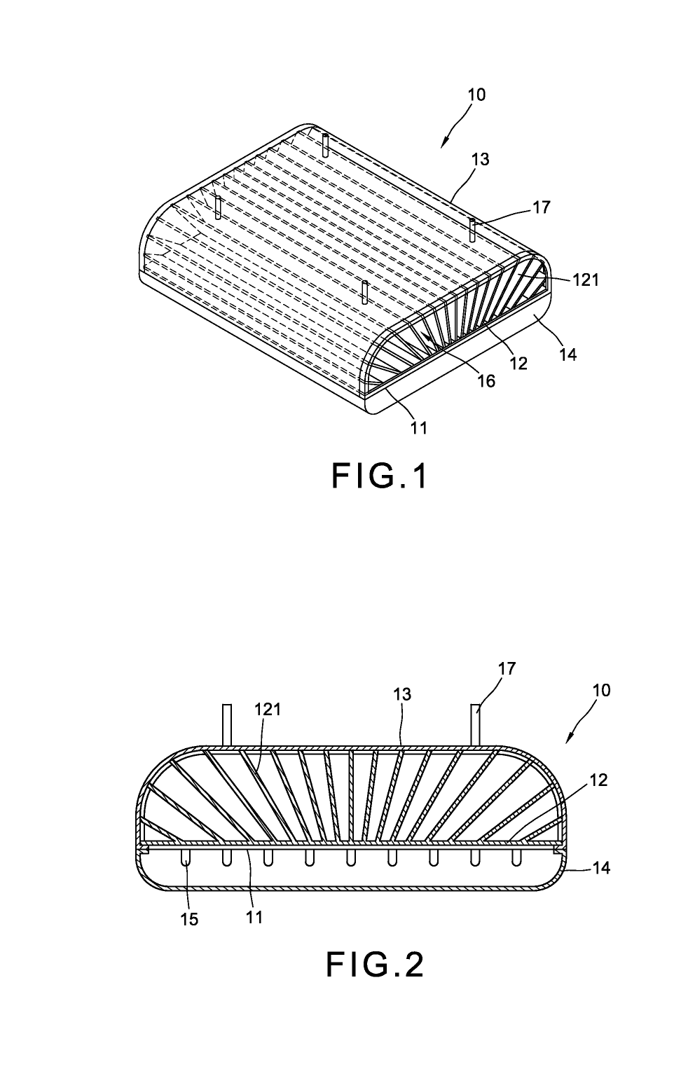

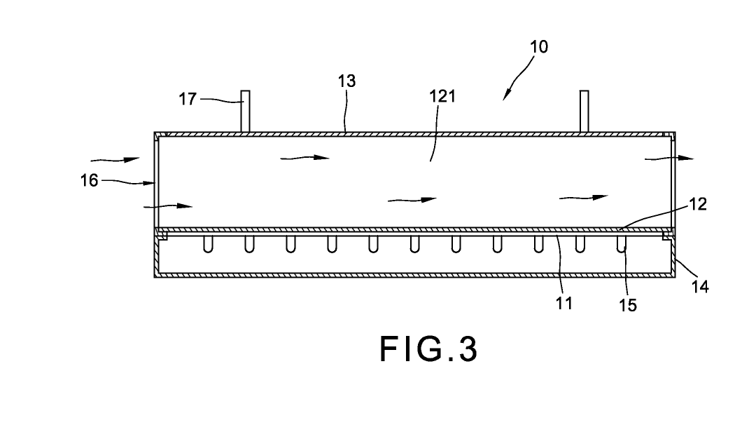

Referring to FIGS. 1 to 3, the Light Emitting Diodes chandelier 10 of the present invention comprises a base board 11, ventilation unit 12, a case 13 and a cover 14. Multiple Light Emitting Diodes (LEDs) 15 are located beneath the base board 11 and the ventilation unit 12 is located above the base board 11. Multiple plates 121 are located on the ventilation unit 12 and arranged radially. The case 13 is mounted to the ventilation unit 12. Both of the plates 121 and the case 13 are made by heat-conductive material, such as Aluminum. The case 13 has two openings 16 defined in two ends thereof as shown in FIG. 3. The case 13 is connected to the top of the ventilation unit 12 so that the tops of the plates 121 are in contact with the ventilation unit 12 to increase the area for ventilation. The case 13 has multiple hooks 17 on the top thereof so as to hang the Light Emitting Diodes chandelier 10 to the ceiling. The cover 14 is a transparent cover and located beneath the LEDs 15. The cover 14 connected to the lower end of the case 13.

The case 13 has the two openings 16 in two ends thereof and the case 13 is made by heat-conductive material which directly contacts the air, so that the ventilation unit 12 is not enclosed. The air convection is efficient and the heat can be brought away quickly. There will be not necessary to increase the ventilation unit 12.

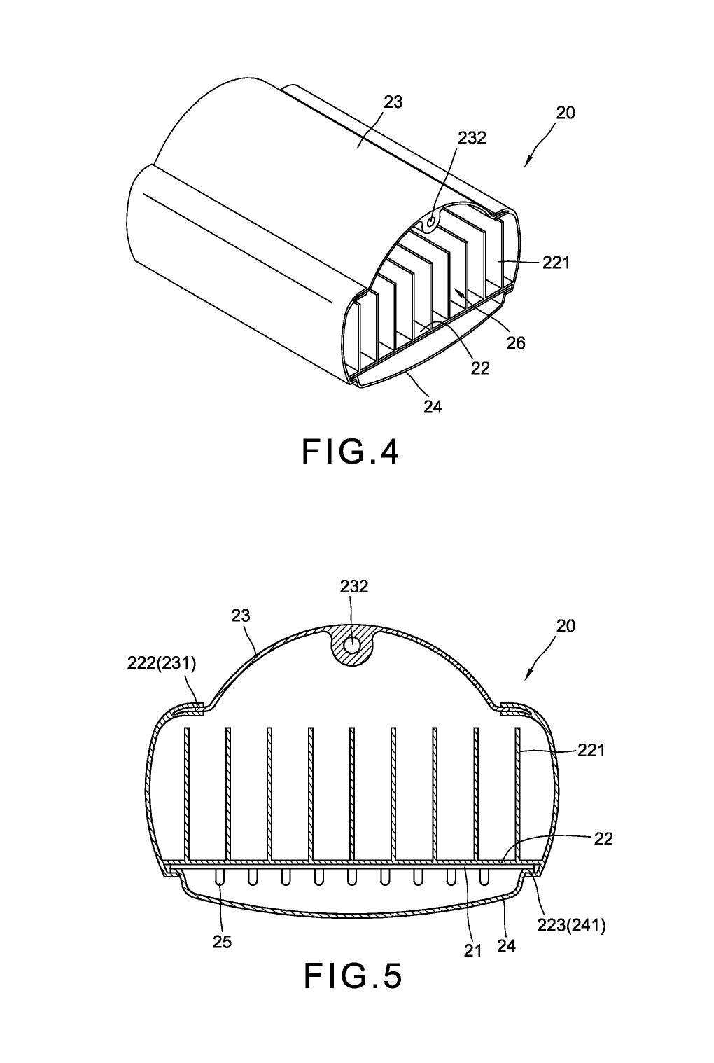

FIGS. 4 and 5 show the second embodiment of the Light Emitting Diodes chandelier which comprises a base board 21, ventilation unit 22, a case 23 and a cover 24. Multiple Light Emitting Diodes (LEDs) 25 are located beneath the base board 21 and the ventilation unit 22 is located above the base board 21. Multiple plates 221 are located on the ventilation unit 22 and arranged upright. The case 23 is mounted to the ventilation unit 22. Both of the plates 221 and the case 23 are made by heat-conductive material, such as Aluminum. The case 23 has two openings 26 defined in two ends thereof. The ventilation unit 22 has slots 222 respectively defined in two sides of the top thereof and the case 23 has two flanges 231 on two sides thereof, the flanges 231 are engaged with the slots 222. The two sides of the top of the ventilation unit 22 are directly in contact with the case 23 to increase the ventilation area. The case 23 has multiple positioning holes 232 for fixing the Light Emitting Diodes chandelier to a ceiling. The cover 24 is a transparent cover and located beneath the LEDs 25, the cover 24 are connected to the lower end of the case 23. The ventilation unit 22 has grooves 223 respectively defined in two sides of the bottom thereof and the cover 24 has two flanges 241 on two sides thereof, the flanges 241 are engaged with the grooves 223.

The case 23 has the two openings 26 in two ends thereof and the case 23 is made by heat-conductive material which directly contacts the air, so that the ventilation unit 22 is not enclosed. The air convection is efficient and the heat can be brought away quickly. There will be not necessary to increase the ventilation unit 22.

While we have shown and described the embodiment in accordance with the present invention, it should be clear to those skilled in the art that further embodiments may be made without departing from the scope of the present invention.

What is claimed is:

1. A Light Emitting Diodes chandelier, comprising:
a base board and multiple Light Emitting Diodes (LEDs) located beneath the base board;
a ventilation unit located above the base board;
a case mounted to the ventilation unit;
a cover being a transparent cover and located beneath the LEDs, the cover connected to a lower end of the case, and
the ventilation unit having multiple plates which are in contact with a top of the ventilation unit, the plates and the case being made by heat-conductive material, the case having two openings defined in two ends thereof.

2. The Light Emitting Diodes chandelier as claimed in claim 1, wherein the plates are radially arranged.

3. The Light Emitting Diodes chandelier as claimed in claim 1, wherein the case has multiple hooks on a top thereof.

4. A Light Emitting Diodes chandelier, comprising:
a base board and multiple Light Emitting Diodes (LEDs) located beneath the base board;
a ventilation unit located above the base board;
a case mounted to the ventilation unit;
a cover being a transparent cover and located beneath the LEDs, the cover connected to a lower end of the case, and
the ventilation unit having multiple plates, the plates and the case being made by heat-conductive material, the case having two openings defined in two ends thereof.

5. The Light Emitting Diodes chandelier as claimed in claim 4, wherein the plates are arranged upright.

6. The Light Emitting Diodes chandelier as claimed in claim 4, wherein the ventilation unit has slots respectively defined in two sides of a top thereof and the case has two flanges on two sides thereof, the flanges are engaged with the slots.

7. The Light Emitting Diodes chandelier as claimed in claim 4, wherein the ventilation unit has grooves respectively defined in two sides of a bottom thereof and the cover has two flanges on two sides thereof, the flanges are engaged with the grooves.

8. The Light Emitting Diodes chandelier as claimed in claim 4, wherein the case has multiple positioning holes for fixing the Light Emitting Diodes chandelier to a ceiling.
